(19) United States
(12) Patent Application Publication
(10) Pub. No.: US 2025/0383662 A1
(43) Pub. Date: Dec. 18, 2025

(54) VEHICULAR SYSTEM AND CONTROL METHOD

(71) Applicant: Aichi Steel Corporation, Tokai-shi, Aichi (JP)

(72) Inventors: Hirotaka MUKUMOTO, Tokai-shi, Aichi (JP); Takayuki ANDO, Tokai-shi, Aichi (JP); Tomohiko NAGAO, Tokai-shi, Aichi (JP); Michiharu YAMAMOTO, Tokai-shi, Aichi (JP)

(73) Assignee: Aichi Steel Corporation, Tokai-shi, Aichi (JP)

(21) Appl. No.: 18/878,195

(22) PCT Filed: Jun. 28, 2023
(86) PCT No.: PCT/JP2023/024088

§ 371 Date: Dec. 23, 2024

(30) Foreign Application Priority Data
Jun. 29, 2022 (JP) 2022-104638

(51) Int. Cl. G05D 1/244; B60W 60/00; G05D 1/245; G05D 111/50

(52) U.S. Cl. CPC G05D 1/244; G05D 1/245; B60W 60/001; G05D 2111/54

(57) ABSTRACT

A vehicular system has a database of position data of discrete points on a route, a first positioning circuit that measures an own vehicle position by using the magnetic markers, a second positioning circuit that measures the own vehicle position by autonomous navigation, and a control circuit that controls the vehicle by taking a deviation of the own vehicle position with respect to the route as a control target. In the database, marker position data with reference to any discrete point is recorded as linked to position data. The first positioning circuit identifies the detected magnetic marker by referring to the database. The control circuit identifies the deviation of the own vehicle position with respect to the route by referring to the database.

### TECHNICAL FIELD

The present invention relates to a vehicular system for causing a vehicle to automatically travel by using magnetic markers disposed in a traveling road.

### BACKGROUND ART

Conventionally, a system has been known in which magnetic markers are disposed along a route along which a vehicle is caused to travel, and the vehicle is caused to automatically travel along the magnetic markers (for example, refer to Patent Literature 1).

### CITATION LIST

### Patent Literature

Patent Literature 1: Japanese Unexamined Patent Application Publication No. 2020-057301

### SUMMARY OF INVENTION

### Technical Problem

However, the above-described conventional system has the following problem. That is, if the magnetic markers are arranged on the route with high position accuracy and the laying positions of the magnetic markers match the positions on the route, the magnetic markers themselves can be control targets for causing the vehicle to automatically travel. On the other hand, if the magnetic markers are installed with high position accuracy, there is a problem in which an increase in installation cost is induced.

The present invention was made in view of the above-described conventional problem, and is to try to provide, in a system that causes a vehicle to automatically travel by using magnetic markers, a vehicular system that can tolerate a positional shift of the magnetic marker with respect to the route.

### Solution to Problem

One mode of the present invention resides in a vehicular system for causing, by using magnetic markers disposed in a route, a vehicle to automatically travel along the route, the system comprising:
a database recording position data of discrete points on the route;
a marker detecting part provided to the vehicle to detect a magnetic marker of the magnetic markers;
a first positioning circuit that measures an own vehicle position, which is a position of the vehicle, with reference to a laying position of the magnetic marker detected by the marker detecting part;
a second positioning circuit that measures the own vehicle position in an intermediate period after the magnetic marker is detected until a new magnetic marker is detected by the marker detecting part; and
a control circuit that controls traveling of the vehicle by taking a deviation of the own vehicle position measured by the first positioning circuit or the second positioning circuit with respect to the route as a control target, wherein
in the database, marker position data indicating a relative position of the magnetic marker with reference to a position of any of the discrete points is recorded as linked to the position data of the discrete points,
the first positioning circuit is configured to identify, when the magnetic marker is detected by the marker detecting part, the magnetic marker positioned in a prescribed range with reference to the own vehicle position by the second positioning circuit by referring to the position data recorded on the database, and
the control circuit is configured to identify the deviation of the own vehicle position measured by the first positioning circuit or the second positioning circuit with respect to the route by referring to the position data recorded on the database.

One mode of the present invention resides in a control method for causing a vehicle to automatically travel by using magnetic markers disposed in a route, the method comprising:
i) providing a vehicular system having:
a database recording position data of discrete points on the route;
a marker detecting part provided to the vehicle to detect a magnetic marker of the magnetic markers;
a first positioning circuit that measures an own vehicle position, which is a position of the vehicle, with reference to a laying position of the magnetic marker detected by the marker detecting part;
a second positioning circuit that measures the own vehicle position in an intermediate period after the magnetic marker is detected until a new magnetic marker is detected by the marker detecting part; and
a control circuit that controls traveling of the vehicle by taking a deviation of the own vehicle position measured by the first positioning circuit or the second positioning circuit with respect to the route as a control target, wherein
in the database, marker position data indicating a relative position of the magnetic marker with reference to a position of any of the discrete points is recorded as linked to the position data of the discrete points,
ii) identifying, by the first positioning circuit, when the magnetic marker is detected by the marker detecting part, the magnetic marker positioned in a prescribed range with reference to the own vehicle position by the second positioning circuit by referring to the database; and
iii) identifying, by the control circuit, the deviation of the own vehicle position measured by the first positioning circuit or the second positioning circuit with respect to the route by referring to the position data recorded on the database.

### EFFECTS OF INVENTION

In the present invention, data indicating the relative position of the magnetic marker with respect to the discrete point on the route is recorded on the database as marker position data. This marker position data is data indicating the relative position of the magnetic marker with respect to the discrete point, that is, data indicating a positional shift of the magnetic marker with respect to the route.

The vehicular system according to the present invention is a system presuming the positional shift of the magnetic marker with respect to the route and having the marker position data indicating this positional shift recorded on the database. In this vehicular system, the positional shift of the magnetic marker with respect to the route is tolerated. Thus, according to the vehicular system in accordance with the present invention, positional requirement accuracy when the magnetic marker is laid can be mitigated, and installation cost of the magnetic markers can be reduced.

Furthermore, in the database of the vehicular system according to the present invention, the above-described marker position data is linked to the position data of the discrete point on the route. Thus, in this vehicular system, the database to be referred to when the magnetic marker is detected and the database to be referred to for causing the vehicle to automatically travel can be shared for use.

If a database recording data indicating the positional shift of the magnetic marker is provided separately from a database recording data indicating the route, when the magnetic marker is detected, it is required to refer to both databases. To measure the own vehicle position by using the magnetic marker, it is required to refer to the former database. To calculate a deviation of the own vehicle position with respect to the route, it is required to refer to the latter database. If a plurality of databases are to be referred to, there is a high possibility that process of searching data and so forth is cumbersome and process loads are increased.

In the vehicular system according to the present invention, the marker position data for use to identify the detected magnetic marker is linked to the position data of the discrete point on the route, and thereby causing the database regarding the magnetic marker and the database regarding the route to be integrated. With the database recording the marker position data corresponding the magnetic marker and the database recording the position data representing the route are integrated, it is possible to suppress loads of process of searching data and so forth.

### BRIEF DESCRIPTION OF DRAWINGS

FIG. 1 is a descriptive diagram of a vehicular system in a first embodiment.

FIG. 2 is a diagram depicting system configuration of the vehicular system in the first embodiment.

FIG. 3 is a diagram depicting a magnetic marker in the first embodiment.

FIG. 4 is a diagram depicting a magnetic marker with a wireless tag in the first embodiment.

FIG. 5 is a diagram depicting a positional relation of magnetic markers with respect to a route.

FIG. 6 is a descriptive diagram of data configuration of a database in the first embodiment.

FIG. 7 is a descriptive diagram of marker position data indicating a position of the magnetic marker in the first embodiment.

FIG. 8 is a flow diagram depicting a flow of process of the vehicular system in the first embodiment.

FIG. 9 is a descriptive diagram of deviation of an own vehicle position with respect to the route in the first embodiment.

FIG. 10 is a flow diagram depicting a flow of process of a vehicular system in a second embodiment.

FIG. 11 is a descriptive diagram of a prescribed range in which a newly-detected magnetic marker can be located in a fourth embodiment.

FIG. 12 is a descriptive diagram depicting enlargement of the prescribed range in the fourth embodiment.

### DESCRIPTION OF EMBODIMENTS

In the configuration of the present invention, it is not imperative that a magnetic marker be arranged on a route where a vehicle is caused to travel. In this configuration, a positional shift of the magnetic marker with respect to the route can be tolerated. By changing marker position data indicating the positional shift of the magnetic marker with respect to the route, even after the magnetic marker is laid, it is possible to make positional adjustment of the route where the vehicle is caused to travel. Also, a wheel base, which is a distance between a front wheel and a rear wheel, is varied in accordance with the type of the vehicle. For example, in a vehicle type with a long wheel base, a wide turn tends to be required in a curve. Thus, it is also preferable that a database for each vehicle type in which marker position data different for each vehicle type is recorded is adopted. With the use of the database for each vehicle type, it is possible to vary the route where the vehicle is caused to travel in accordance with the vehicle type while using the same magnetic markers.

Modes for implementation of the present invention are specifically described by using the following embodiments.

### First Embodiment

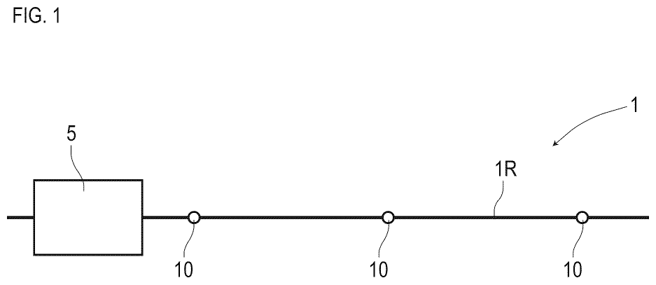

The present embodiment is an example regarding vehicular system 1 for causing vehicle 5 to automatically travel by using magnetic markers 10. Details of this are described by using FIG. 1 to FIG. 9.

Vehicular system 1 of the present embodiment is a system for causing vehicle 5 to automatically travel along route 1R as in FIG. 1. In this vehicular system 1, magnetic markers 10 are disposed as spaced a predetermined space (for example, 2 m) along route 1R. Magnetic markers 10 are laid as tolerating, to some extent, a positional shift with respect to route 1R. In vehicular system 1, marker position data indicating the positional shift of magnetic marker 10 with respect to route 1R is managed.

In vehicular system 1 of the present embodiment, when magnetic marker 10 is detected by vehicle 5, an own vehicle position (position of the vehicle) is measured with reference to the laying position of detected magnetic marker 10. On the other hand, in an intermediate period from a time when any magnetic marker 10 is detected until new magnetic marker 10 is detected, that is, in a period in which vehicle 5 is positioned between adjacent magnetic markers 10, the own vehicle position is measured by autonomous navigation (dead reckoning, DR) with reference to the own vehicle position measured when magnetic marker 10 detected immediately before is detected.

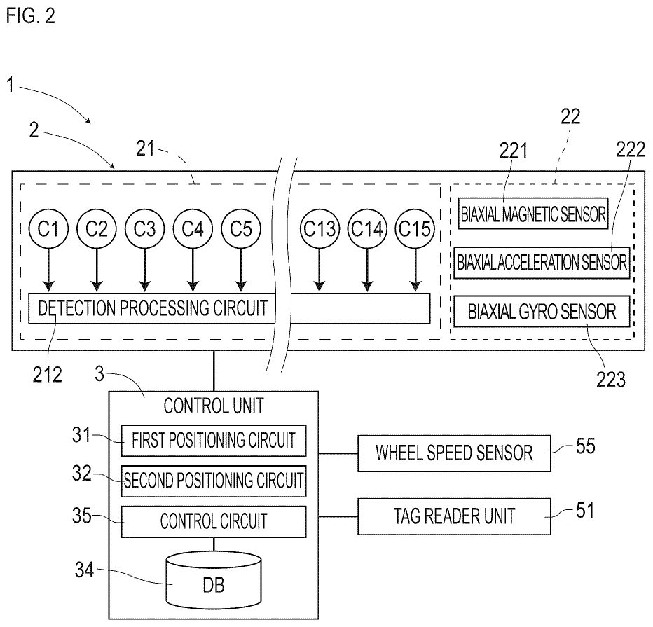

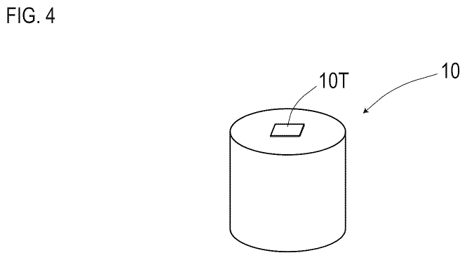

Vehicular system 1 is configured to include, as in FIG. 2, measuring unit 2, control unit 3, wheel speed sensor 55, tag reader unit 51, an actuator not depicted, and so forth. Measuring unit 2 is a unit that measures magnetism, yaw rate, acceleration, and so forth. Wheel speed sensor 55 is a sensor that detects the amount of revolution of a wheel (omitted in the drawing). Tag reader unit 51 is a communication unit that reads tag information from wireless tag 10T (FIG. 4). In the present embodiment, wireless tag 10T is attached to part of magnetic markers 10. The actuator is a driving device, not depicted in the drawing, that actuates an engine throttle, steering, brake, and so forth.

Control unit 3 is a computer unit including an electronic substrate (omitted in the drawing) having mounted thereon a CPU (central processing unit) that performs various arithmetic operations, memory elements such as ROM (read only memory) and RAM (random access memory), and so forth. Control unit 3 performs, with the CPU executing various software programs read from the ROM, each of functions of first positioning circuit 31, second positioning circuit 32, and control circuit 35. First positioning circuit 31 is a circuit that measures the own vehicle position with reference to magnetic marker 10. Second positioning circuit 32 is a circuit that measures the own vehicle position by autonomous navigation. Control circuit 35 is a circuit for controlling traveling of the vehicle.

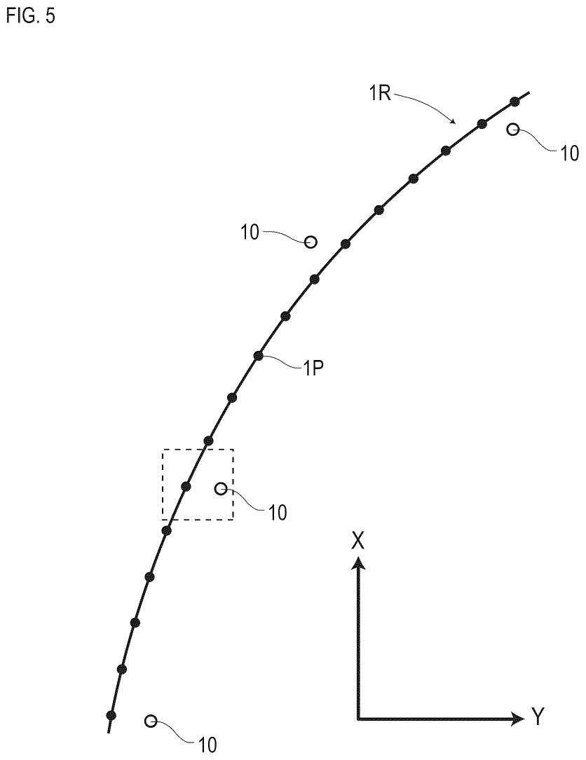

By controlling the actuator that actuates the engine throttle, steering, brake, and so forth, control circuit 35 controls traveling of the vehicle 5. Also, in control unit 3, database 34 having position data of discrete points 1P (FIG. 5) on route 1R recorded thereon is constructed by using a storage area of the ROM.

Details of vehicular system 1 of the present embodiment are described in detail below.

### Magnetic Marker

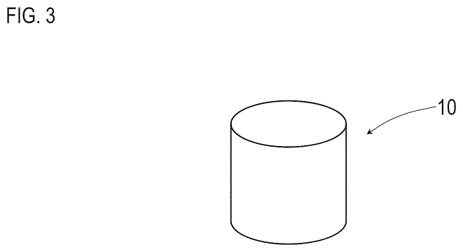

Magnetic marker 10 (FIG. 3 and FIG. 4) is a road marker laid in a road surface of a traveling road of vehicle 5 (refer to FIG. 1). Magnetic markers 10 are arranged as spaced, for example, 2 m, along route 1R where vehicle 5 is caused to automatically travel.

Magnetic marker 10 forms a columnar shape having a diameter of 28 mm and a height of 20 mm. Magnetic marker 10 is laid, for example, in a state of being accommodated in an accommodation hole (omitted in the drawing) provided in the road surface (refer to FIG. 1). A magnet forming magnetic marker 10 is a permanent magnet (ferrite plastic magnet) having magnetic powder of iron oxide as a magnetic material dispersed into a polymer material as a base material. This magnet has a characteristic of a maximum energy product (BHmax)=6.4 kJ/m².

Columnar-shaped magnetic marker 10 has the N pole on one end face side and the S pole on the other end face side. When the magnetic marker is accommodated in the accommodation hole, the magnetic polarity to be determined on vehicle 5 side is varied in accordance with which end face is oriented upward. At a height of 250 mm, which is an upper limit of a range assumed as an attachment height of measuring unit 2 of 100 to 250 mm, magnetic flux density of magnetism with which magnetic marker 10 acts is 8 μT (microteslas).

Part of magnetic markers 10 (FIG. 4) have a wireless tag 10T retained on its upper surface. Wireless tag 10T operates by electric power wirelessly supplied, and wirelessly outputs tag information including a tag ID. Note that in the configuration of the present embodiment, only magnetic marker 10 adjacent in an upstream side to magnetic marker 10 retaining wireless tag 10T is buried so as to have the S pole on the upper surface and other magnetic markers 10 are buried so as to have the N pole on the upper surface. S-pole magnetic marker 10 is used, as will be described further below, to determine whether tag information read by tag reader unit 51 is correct.

### Wheel Speed Sensor

Wheel speed sensor 55 (FIG. 2) is an example of a first sensor for measuring the amount of revolution of the wheel of vehicle 5. Wheel speed sensor 55 outputs one pulse of a vehicle speed signal every time the wheel rotates once. In the configuration of the present embodiment, the diameter of the wheel is set on the system side as a set value, and the wheel speed, the traveling distance, and so forth can be measured using the vehicle speed signal.

### Tag Reader Unit

Tag reader unit 51 (FIG. 2) is a unit that reads tag information from wireless tag 10T retained on magnetic marker 10. This tag reader unit 51 reads the tag information by wirelessly supplying electric power to operate wireless tag 10T. As for the tag information read by tag reader unit 51, whether the tag information is correct is determined by using magnetic polarity of magnetic marker 10 detected immediately before. In the configuration of the present embodiment, it is determined that the tag information read by tag reader unit 51 is correct on condition that magnetic marker 10 detected immediately before has the S pole.

### Measuring Unit

Measuring unit 2 (FIG. 2) is a unit in which sensor array 21 forming one example of a marker detecting part and IMU (Inertial Measurement Unit) 22 for autonomous navigation 22 are integrated. Measuring unit 2 is a rod-shaped unit elongated in a vehicle-width direction. Measuring unit 2 is attached, for example, inside the front bumper (omitted in the drawing) of vehicle 5 in a state of facing the road surface. In vehicle 5 of the present embodiment, the attachment height of measuring unit 2 with reference to the road surface is 200 mm.

Sensor array 21 includes fifteen magnetic sensors Cn (n is an integer of 1 to 15) arrayed on a straight line equidistantly with 10 cm pitches and detection processing circuit 212 including a CPU and so forth not depicted (refer to FIG. 2). This sensor array 21 has the array direction of fifteen magnetic sensors along the vehicle-width direction, and is attached to vehicle 5 so that magnetic sensor C8 is positioned at the center in the vehicle-width direction.

Magnetic sensors Cn are MI sensors that detect magnetism by using the known MI effect (Magneto Impedance Effect), in which the impedance of a magneto-sensitive body such as an amorphous wire sensitively changes in response to the external magnetic field. In each magnetic sensor Cn, magneto-sensitive bodies, not depicted, such as amorphous wires are arranged along two axial directions orthogonal to each other and, this allows detection of magnetism acting the two axial directions orthogonal to each other. In the present embodiment, each magnetic sensor Cn is incorporated in sensor array 21 so as to be able to detect magnetic components in a forwarding direction and the vehicle-width direction of vehicle 5. Magnetic sensors Cn as MI sensors have high sensitivity and can detect, with high reliability, magnetism with which magnetic marker 10 acts.

Detection processing circuit 212 (FIG. 2) of sensor array 21 is an arithmetic circuit that performs marker detection process for detecting magnetic marker 10 and other processes. This detection processing circuit 212 is configured by using a CPU, not depicted, that performs various arithmetic operations, memory elements such as ROM (read only memory) and RAM (random access memory) not depicted, and so forth.

Detection processing circuit 212 obtains sensor signals outputted from each magnetic sensor Cn to perform marker detection process. When detecting magnetic marker 10, detection processing circuit 212 inputs the marker detection result, indicating as such, to first positioning circuit 31 (control unit 3). In the marker detection process, in addition to detection of magnetic marker 10, measurement of a lateral shift amount of vehicle 5 with respect to magnetic marker 10 is performed. In measurement of the lateral shift amount, the position of magnetic sensor C8 positioned at the center in sensor array 21 is set as a representative point of vehicle 5. The lateral shift amount is a shift amount of this representative point in the vehicle-width direction with respect to magnetic marker 10.

IMU 22 incorporated in measuring unit 2 is an inertial navigation unit that estimates a relative position of vehicle 5 by inertial navigation. IMU 22 includes biaxial magnetic sensor 221, which is an electronic compass that measures azimuth, biaxial acceleration sensor 222 that measures acceleration, and biaxial gyro sensor 223 that measures a yaw rate. IMU 22 inputs the azimuth, acceleration, and yaw rate to second positioning circuit 32 (control unit 3). Note that biaxial gyro sensor 223 is one example of a second sensor that obtains the yaw rate, which is a rotational angular velocity of vehicle 5 about the axis in a vertical direction.

### First Positioning Circuit

First positioning circuit 31 (FIG. 2) is a circuit that measures the own vehicle position with reference to any magnetic marker 10 detected by sensor array 21 (marker detecting part). When obtaining from sensor array 21 the marker detection result indicating that magnetic marker 10 has been detected, first positioning circuit 31 measures the own vehicle position with reference to the laying position of the magnetic marker 10. Note that a method by which first positioning circuit 31 identifies the detected magnetic marker 10, a method by which the own vehicle position is measured using the detected magnetic marker 10, and so on, will be described in detail further below.

### Second Positioning Circuit

Second positioning circuit 32 (FIG. 2) is a circuit that measures the own vehicle position in the period from the time when any magnetic marker 10 is detected until new magnetic marker 10 is detected, that is, the intermediate period in which vehicle 5 is positioned midway between adjacent magnetic markers 10 on route 1R. Second positioning circuit 32 uses the yaw rate outputted by IMU 22, the vehicle speed signal outputted by wheel speed sensor 55, and so forth, and estimates a relative position with respect to the own vehicle position measured with reference to magnetic marker 10. Second positioning circuit 32 measures, as the own vehicle position, a position obtained by offsetting the reference own vehicle position by the relative position.

Second positioning circuit 32 calculates change amount dθ in vehicle azimuth by time integration of the yaw rate, and calculates displacement (dx, dy) by time integration of vehicle speed V. dx is a displacement amount of the vehicle in a front-rear direction (direction corresponding to vehicle azimuth). dx is calculated by time integration of a component of vehicle speed V in the front-rear direction. dy is a displacement amount of the vehicle in the width direction. dy is calculated by double integration of time integration of the yaw rate and time integration of a component of vehicle speed V in the width direction. dθ, dx, dy are calculated by the following Equation 1. Note that in this equation, technical approximation based on the fact that dθ is sufficiently small is included.

$$d θ = \int γ dt , \qquad [ Equation 1 ]$$

$$\begin{matrix}d x = \int V cos ( d θ ) dt \\ = \int Vdt ,\end{matrix}$$

$$\begin{matrix}d y = \int V sin ( d θ ) dt \\ = \int Vd θ dt \\ = \int V ( \int γ {dt}^{′} ) dt\end{matrix}$$

Second positioning circuit 32 measures a position obtained by shifting the reference position (own vehicle position as a reference) by displacement (dx, dy) as the own vehicle position. Also, second positioning circuit 32 estimates new vehicle azimuth by shifting the vehicle azimuth when the vehicle is positioned at the reference position by do.

### Database

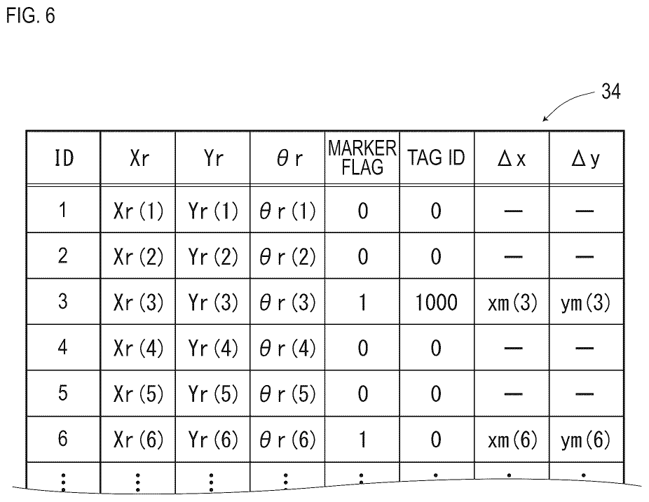

In vehicular system 1 of the present embodiment, route 1R is represented by discrete points 1P (refer to FIG. 5). Database 34 (FIG. 6) is a database where discrete point data including position data of discrete points 1P on route 1R are recorded. In database 34, each discrete point 1P per 0.1 m on the route is provided with an ID, which is identification information, and discrete point data is recorded for each ID. In part of discrete point data, marker position data is recorded as linked to position data of discrete point 1P.

Position data is data indicating a two-dimensional position and a route direction in a two-dimensional global coordinate system defined by the X axis and the Y axis (refer to FIG. 5). The position data of discrete point 1P is configured to include coordinate data (Xr, Yr) indicating a two-dimensional coordinate position with an X coordinate and a Y coordinate and angle θr indicating the gradient in the route direction with respect to the X-axis direction (one example of azimuth data indicating a direction of the route). For example, position data of discrete point 1P with ID=1 in FIG. 6 is (Xr(1), Yr(1)), θr(1), and position data of discrete point 1P with ID=2 is (Xr(2), Yr(2)), θr(2), and so forth.

Included in the discrete point data (FIG. 6) are a marker flag indicating whether marker position data is linked to the position data of discrete point 1P and identification information (tag ID) of wireless tag 10T retained on magnetic marker 10 corresponding to the marker position data. The marker flag is a binary value of zero or 1, and the flag value when marker position data is linked is 1. The tag ID is identification information included in the tag information outputted from wireless tag 10T. Note that, as described above, magnetic marker 10 retaining wireless tag 10T is part of magnetic markers 10. As for magnetic marker 10 not retaining wireless tag 10T, the tag ID is zero or NULL.

The marker position data is data indicating relative position (Δx, Δy) of magnetic marker 10 with respect to nearest discrete point 1P. This marker position data represents a positional shift of magnetic marker 10 with respect to route 1R. Marker position data (Δx, Δy) is a two-dimensional position in a local coordinate system taking corresponding discrete point 1P as an origin, a route direction as an x axis, and an orthogonal direction as a y axis. The marker position data is two-dimensional offset information formed of a combination of shift amount Δx in the x direction and shift amount Δy in the y direction in this local coordinate system.

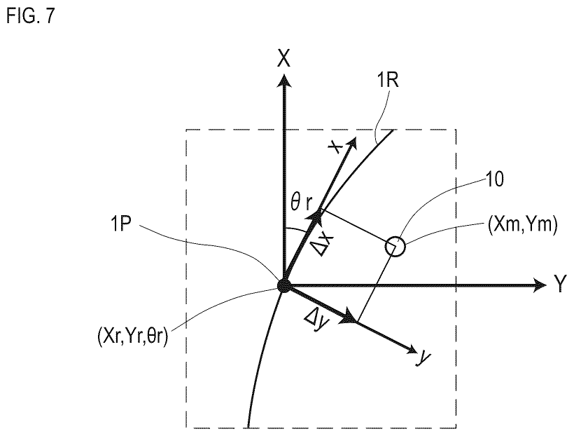

As in FIG. 7 depicting an area surrounded by a broken line in FIG. 5 in an enlarged manner, for example, a case is assumed in which magnetic marker 10 is positioned near discrete point 1P whose positional data in the global coordinate system is (Xr, Yr, θr). In this case, marker position data (Δx, Δy) of magnetic marker 10 is linked to position data (Xr, Yr, θr) of discrete point 1P. Coordinate position (Xm, Ym) of magnetic marker 10 in the global coordinate system can be calculated by the following Equation 2.

$$[ \begin{matrix}Xm \\ Ym\end{matrix} ] = [ \begin{matrix}X r \\ Yr\end{matrix} ] + [ \begin{matrix}cos θ r & - sin θ r \\ sin θ r & cos θ r\end{matrix} ] [ \begin{matrix}Δ x \\ Δ y\end{matrix} ] \qquad [ Equation 2 ]$$

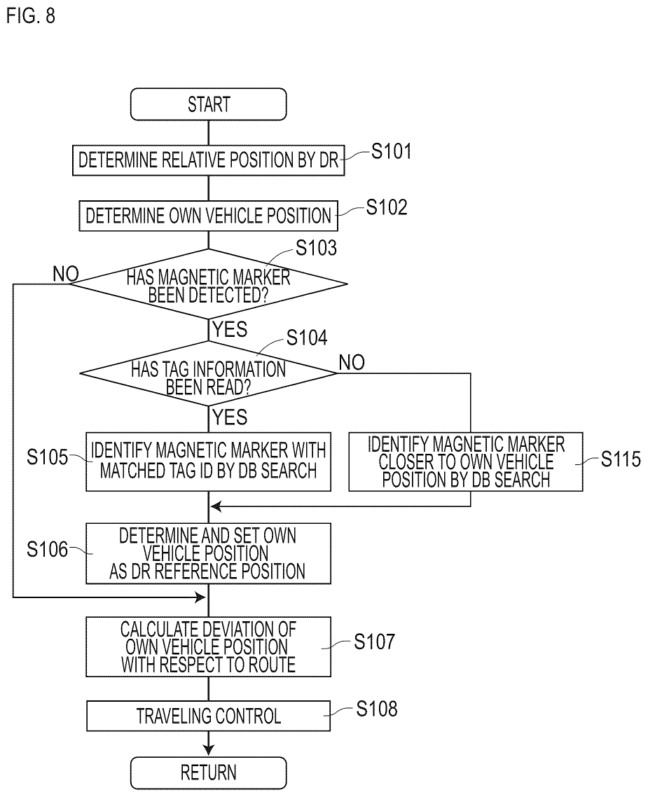

Next, the operation of vehicular system 1 configured as described above is described along a flow diagram of FIG. 8. While vehicle 5 is moving by automatic traveling, control unit 3 repeatedly performs a process of measuring the relative position by autonomous navigation (Dead Reckoning, DR) (S101). Note that control unit 3 takes a position where an absolute position is identified as the reference position and estimates the relative position, which is a displacement amount after passage over the reference position. The own vehicle position measured with reference to magnetic marker 10, a control start position, or the like can be the reference position. Control unit 3 measures, as the own vehicle position, a position obtained by shifting the reference position by the relative position (S102).

While vehicle 5 is moving, the above-described marker detection process for detecting magnetic marker 10 is repeatedly performed. When magnetic marker 10 is detected (S103: YES), it is first determined whether tag information has been read (S104). If tag information including a tag ID has been read (S104: YES), control unit 3 refers to (searches) database 34 (FIG. 2, DB), and identifies discrete point data including the read tag ID. Control unit 3 identifies magnetic marker 10 corresponding to the marker position data in this discrete point data as magnetic marker 10 detected at step S103 described above (S105).

Control unit 3 reads marker position data (Δx, Δy) and position data (Xr, Yr, θr) of discrete point 1P from the discrete point data identified as described above (refer to FIG. 6) and, as in Equation 2 described above, calculates coordinate position (Xm, Ym) of magnetic marker 10. Control unit 3 measures, as the own vehicle position, a position obtained by shifting coordinate position (Xm, Ym) of magnetic marker 10, as a reference, by the lateral shift amount measured by the marker detection process (S106). Note that this own vehicle position serves as the reference position when the relative position is measured thereafter by autonomous navigation (dead reckoning, DR) at step S101 described above.

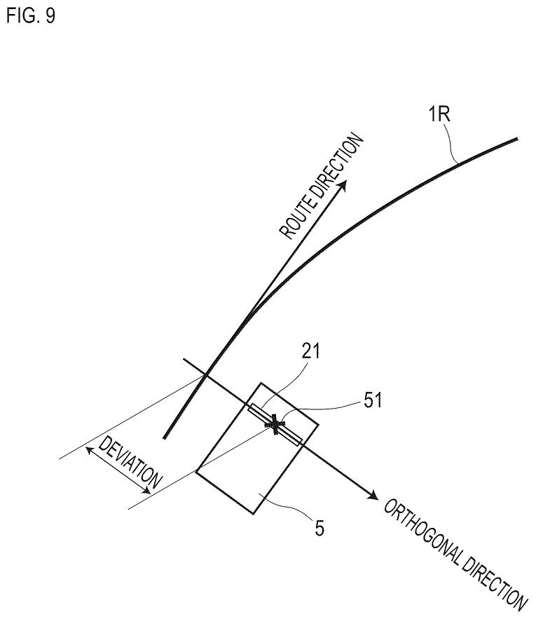

Next, control unit 3 calculates, as in FIG. 9, a deviation of the own vehicle position (position indicated by sign 51) with respect to route 1R (S107). Here, the discrete point data of discrete point 1P positioned near the own vehicle position has already been read on database 34 by the process at step S105 described above. Based on the read discrete point data and discrete point data of preceding and subsequent discrete points 1P, control unit 3 identifies the position of route 1R, and calculates the deviation of the own vehicle position. This deviation is a distance by which vehicle 5 is away from route 1R in an orthogonal direction with respect to the route direction. By taking this deviation as a control target, control unit 3 controls traveling of vehicle 5 so that this deviation is brought to zero (S108).

On the other hand, when no tag information is read from magnetic marker 10 detected at step S103 described above (S104: NO), by referring to database 34, control unit 3 identifies magnetic marker 10 positioned nearest to the own vehicle position measured by autonomous navigation (S115).

Measurement of the own vehicle position after magnetic marker 10 is identified (S106), calculation of the deviation (S107), and traveling control (S108) are as described above. Similarly to the case when magnetic marker 10 with wireless tag 10T is detected, the own vehicle position identified with reference to the laying position of magnetic marker 10 serves as the reference position when the relative position is estimated by autonomous navigation at step S101 described above.

When magnetic marker 10 is not detected at step S103 described above (S103: NO), based on the own vehicle position measured at step S102 described above, control unit 3 performs control similar to the above for causing vehicle 5 to automatically travel along route 1R (S107→S108).

One of the technical features of vehicular system 1 of the present embodiment configured as described above is in database 34 in which marker position data indicating the laying positions of magnetic markers 10 (relative positions with respect to discrete points 1P) is recorded as linked to position data of discrete points 1P on the route 1R.

In the configuration of the present embodiment, marker position data indicating relative positions with respect to discrete points 1P on route 1R is set, and the presence of the positional shift of magnetic marker 10 with respect to route 1R is presumed. In this vehicular system 1, the positional shift of magnetic marker 10 with respect to route 1R is tolerated, and positional requirement accuracy regarding the laying positions of magnetic markers 10 is suppressed. Therefore, according to vehicular system 1, it is possible to install magnetic markers 10 with high efficiency and suppress installation cost.

In the configuration of the present embodiment, it is not imperative that magnetic marker 10 be arranged on route 1R, and the positional shift of magnetic marker 10 with respect to route 1R is tolerated. By changing marker position data indicating the positional shift of magnetic marker 10 with respect to route 1R, it is possible to make positional adjustment of the route where the vehicle actually travels without changing the laying position of magnetic marker 10. Also, the wheel base between the front wheel and the rear wheel is varied in accordance with the type of the vehicle and, for example, in a vehicle type with a long wheel base, a wide turn tends to be required in a curve. Thus, a database for each vehicle type in which marker position data different for each vehicle type is recorded is also preferably adopted. With the use of the database for each vehicle type, it is possible to adjust the route where the vehicle actually travels in accordance with the vehicle type while using the same magnetic markers.

In vehicular system 1 of the present embodiment, by linking the marker position data to the position data of discrete point 1P on route 1R, the database of the position data and the database of the marker position data are integrated as database 34 for shared use. In vehicular system 1 including this database 34, by referring to database 34 for identifying detected magnetic marker 10, it is possible to also identify discrete point 1P positioned near magnetic marker 10. Thus, in vehicular system 1 of the present embodiment, after magnetic marker 10 is identified with reference to database 34 and the own vehicle position is measured, when the deviation of the own vehicle position with respect to the route is calculated, it is not required to refer to another database in which positional information of the route is recorded. With less number of types of databases to be referred to, it is possible to reduce load required for data search process.

Note that the marker position data corresponding to the magnetic marker is linked to the position data of the nearest discrete point of the magnetic marker in the present embodiment. The position data to which the marker position data is to be linked may not be the position data of the nearest discrete point of the magnetic marker, and may be position data of the discrete point located near the magnetic marker. Furthermore, while the marker position data corresponding to the magnetic marker is linked to position data of any one discrete point in the present embodiment, marker position data corresponding to one magnetic marker may be linked to position data of a plurality of discrete points nearby.

In FIG. 6, in discrete point data in which the marker flag is 1, that is, the marker position data of the magnetic marker is linked to the position data, data indicating magnetic polarity of the corresponding magnetic marker may be included. In this case, when the detected magnetic marker is identified, matching of the magnetic polarity of the detected magnetic marker and magnetic polarity data in the discrete point data can be set as a magnetic marker identification condition. In consideration of matching of the magnetic polarity of the magnetic marker, it is possible to suppress a possibility of erroneously identifying the detected magnetic marker as another magnetic marker.

### Second Embodiment

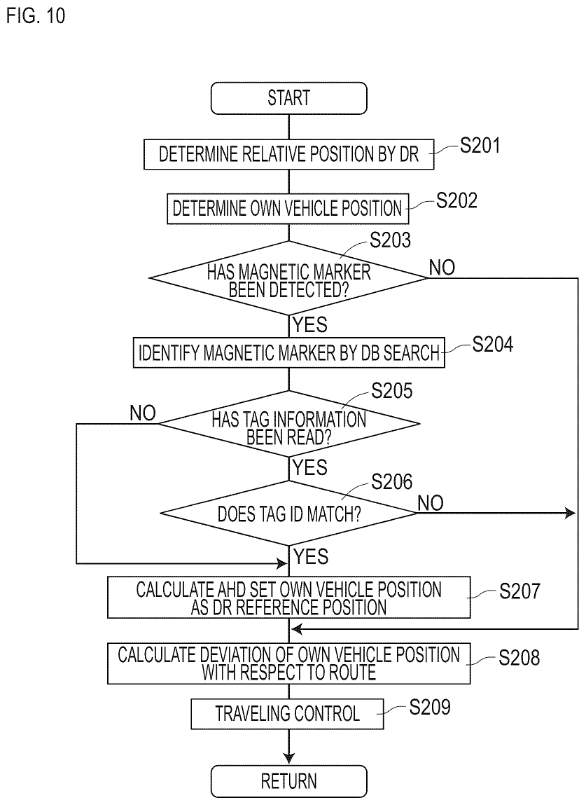

The present embodiment is an example in which, based on the vehicular system of the first embodiment, the process when the magnetic marker with the wireless tag is detected is changed. Details of this are described with reference to FIG. 10.

In the configuration of the first embodiment, when the magnetic marker with the wireless tag is detected (S103 in FIG. 8: YES→S104: YES), the magnetic marker corresponding to the tag ID is identified with reference to database 34 (S105 in FIG. 8). By contrast, in the present embodiment, as in a flow diagram of FIG. 10, when the magnetic marker is identified, tag ID is not used. In this point, the present embodiment is different from the first embodiment.

Steps S201 to S203 in FIG. 10 are processes similar to steps S101 to S103 in FIG. 8. In the present embodiment, when the magnetic marker is detected (S203: YES), irrespective of whether tag information is read, the magnetic marker positioned nearest to the own vehicle position is first identified by autonomous navigation (S204). This step S204 is a process similar to step S115 (FIG. 8) of the first embodiment.

Then, after the magnetic marker is identified in this manner, whether tag information is read is determined (S205). If tag information has been read (S205: YES), it is determined whether the tag ID included in that tag information matches the tag ID of the magnetic marker identified at step S204 described above (S206). When the tag ID matches (S206: it is determined that the tag information has been correctly read and no erroneous detection of the magnetic marker has occurred, and the own vehicle position is measured with reference to the magnetic marker (S207). In this case, the own vehicle position measured at step S202 described above is discarded.

If tag information has not been read (S205: NO), a check on the tag ID as described above (S206) is not performed. With reference to the magnetic marker identified at step S204 described above unchanged, the own vehicle position is measured (S207). Note that irrespective of whether the procedure goes though determination at step S206, the own vehicle position measured at step S207 is handled as the reference position for positioning by autonomous navigation (dead reckoning, DR) thereafter.

On the other hand, when the tag ID does not match (S206: NO), it is determined that some error has occurred, such as an error in reading the tag information or erroneous detection of the magnetic marker. In this case, the magnetic marker detection result is discarded, and measurement of the own vehicle position with reference to the magnetic marker (S207) is detoured. In this case, the own vehicle position measured at step S202 described above is kept unchanged.

After measurement of the own vehicle position is fixed as described above, process of calculating the deviation with respect to the route (S208) and traveling control by taking this deviation as the control target (S209) are performed. Steps S208 and S209 are processes similar to steps S107 and S108 in FIG. 8.

In the present embodiment, irrespective of the check with the tag ID, the own vehicle position measured with reference to the magnetic marker is set as the reference position in autonomous navigation thereafter. In place of this, only the own vehicle position measured with reference to the magnetic marker with its tag ID checked may be set as the reference position in autonomous navigation thereafter. The own vehicle position measured with the magnetic marker not checked with the tag ID can be used as an observation position for improving accuracy in autonomous navigation.

Note that other configurations and operations and effects are similar to those of the first embodiment.

### Third Embodiment

The present embodiment is an example in which, based on vehicular system of the first embodiment, a criterion when the detected magnetic marker (without a wireless tag) is identified is provided. Details of this are described with reference to FIG. 2 and FIG. 8.

In the configuration of the present embodiment, threshold process regarding distance L (Equation 3) between laying position (xm, ym) of the magnetic marker identified at step S115 in FIG. 8 and own vehicle position (x, y) measured at immediately preceding step S102 is performed. In this threshold process, for example, lateral width Lo of sensor array 21 is set as a threshold value.

$$L = \sqrt{{( xm - x )}^{2} + {( ym - y )}^{2}} \qquad [ Equation 3 ]$$

When distance L exceeds threshold value Lo, control unit 3 make a determination such as that, for example, an erroneous detection of the magnetic marker has occurred. In this case, control unit 3 detours measurement of the own vehicle position based on the detected magnetic marker. According to this determination, it is possible to avoid a situation in advance in which, for example, an erroneous own vehicle position different from the proper position is measured in response to the erroneous detection of the magnetic marker or the like. The own vehicle position measured with reference to the magnetic marker serves as the reference position at the time of measurement of the own vehicle position by autonomous navigation thereafter. By avoiding measurement of the own vehicle position based on the erroneous detection of the magnetic marker, it is possible to keep accuracy in measurement by autonomous navigation thereafter.

Note that threshold value Lo may be dynamically changed in accordance with movement distance d of the vehicle after passage over the reference position. As movement distance d is longer, an error of measurement of the own vehicle position by autonomous navigation can be increased. Thus, as movement distance d is longer, distance L between the laying position of the correctly-detected magnetic marker and the own vehicle position tends to be longer.

To address this, for example, threshold value Lo may be set as in Equation 4. This Equation 4 represents an example in which threshold value Lo is dynamically changed by a quadratic function of movement distance d. Threshold value Lo by Equation 4 abruptly increases as movement distance d increases.

$$Lo = c 2 \times {d}^{2} + c 1 \times d + c 0 \qquad [ Equation 4 ]$$

$$c 0 , c 1 , c 2 are constants$$

As for threshold value Lo that abruptly increases as movement distance d increases, an upper-limit value may be set. By setting the upper-limit value, it is possible to avoid in advance the erroneous detection of magnetic marker 10 due to setting threshold value Lo to an excessive value such as exceeding the upper-limit value. Note that as a situation in which threshold value Lo reaches the upper-limit value, the situation can be thought in which a situation in which no magnetic marker has been detected continues to cause movement distance d after passage over the reference position to become excessive. In this case, there is a possibility of occurrence of some trouble, such as a failure of the magnetic sensor or departure from the route.

Movement distance d is a movement distance of the vehicle after the own vehicle position is measured with reference to the laying position of detected magnetic marker 10, that is, a distance travelled by the vehicle after passing over correctly-detected magnetic marker 10. Threshold process regarding this movement distance d may be performed. When movement distance d is equal to or larger than or exceeds a predetermined distance set in advance, a notification indicating that movement distance d is excessive may be issued, or vehicle control such as automatic traveling may be stopped. Note that when vehicle control is stopped, control is preferably stopped after the vehicle is moved to a safe location. Notification and stopping vehicle control may be made in accordance with the result of threshold process regarding threshold value Lo itself.

Note that other configurations and operations and effects are similar to those of the first embodiment or the second embodiment.

### Fourth Embodiment

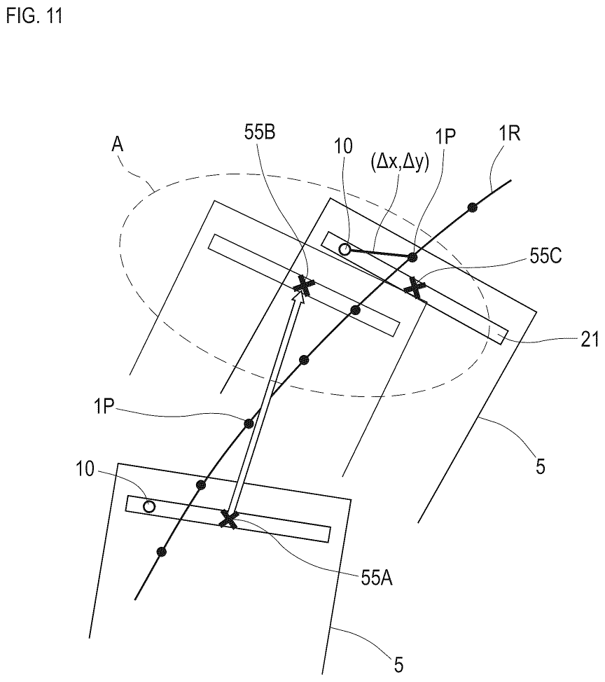

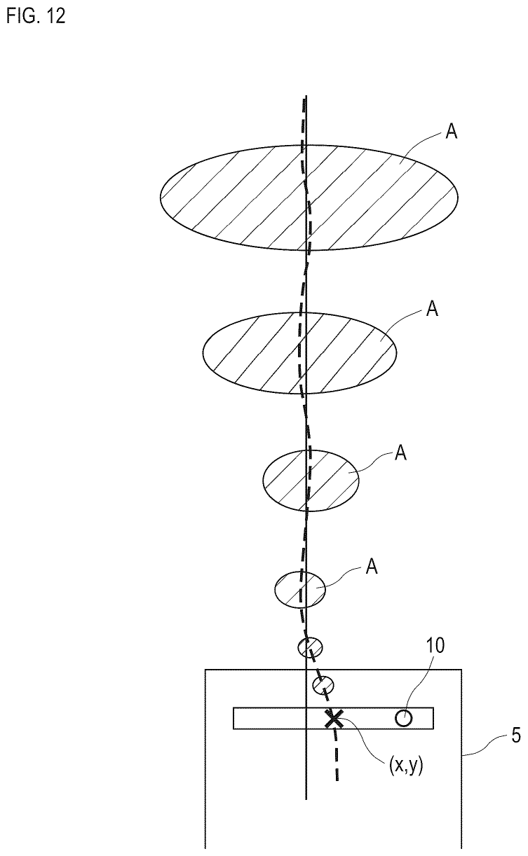

The present embodiment is an example in which, based on the vehicular system of the first or second embodiment, prescribed range A where the detected magnetic marker can be located is set. Details of this are described with reference to FIG. 2, FIG. 11, and FIG. 12.

FIG. 11 depicts own vehicle position 55A measured by using magnetic marker 10, own vehicle position 55B measured by autonomous navigation by taking this own vehicle position 55A as the reference position, and own vehicle position 55C measured with reference to newly detected magnetic marker 10. In the configuration of the present embodiment, prescribed range A having a possibility that newly detected magnetic marker 10 is located as centering own vehicle position 55B is set. Although details will be described further below, prescribed range A is an area that is set in consideration of a positioning error by autonomous navigation and extends as the movement distance from the reference position is longer (refer to FIG. 12).

In the configuration of the present embodiment, when any magnetic marker 10 is detected, among discrete point data recorded on database 34, ones including marker position data are selected. Then, for each piece of selected discrete point data, a positional shift is made from a corresponding discrete point (position indicated by position data to which the marker position data is linked) by a relative position indicated by the marker position data, thereby identifying the laying position of magnetic marker 10 corresponding to that marker position data. It is determined whether the laying position of magnetic marker 10 identified in a manner as described above belongs to prescribed range A. With this, magnetic marker 10 positioned in prescribed range A is selected, and newly detected magnetic marker 10 is identified. Own vehicle position 55C is measured based on the laying position of newly-detected magnetic marker 10 by shifting the position from the laying position by the lateral shift amount with respect to magnetic marker 10.

Next, a method of setting prescribed range A is described. In the present embodiment, prescribed range A is set in view of a method of calculating relative position (dx, dy) by autonomous navigation. When the yaw rate measured by IMU 22 is γ and the vehicle speed based on the vehicle speed signal of wheel speed sensor 55 is V, relative position (dx, dy) is calculated as in Equation 1 described above. Note that dx is a relative displacement along the front-rear direction of the vehicle (direction corresponding to vehicle azimuth). dy is a relative displacement along the width direction of the vehicle.

As in Equation 1, relative displacement dx is calculated by single integration. On the other hand, relative displacement dy requires integration twice (double integration) for calculation. As a matter of course, an error due to error γe of yaw rate γ and error Ve of vehicle speed V expand in accordance with integration. As the movement distance after passage over the reference position increases and an integration period increases, errors of relative displacement dx and relative displacement dy expand.

Furthermore, when integration doubles (double integration) as in equation for calculating relative displacement dy, the degree of expansion of error in accordance with the movement distance becomes stronger. Thus, of relative displacement dx and relative displacement dy, relative displacement dy requiring double integration for calculation can have a larger calculation error.

This tendency of error of relative displacement dx and relative displacement dy can be described by development of the following equations. For example, if vehicle azimuth θ0 (front-rear direction of the vehicle) at reference position (x0,y0) as a movement start position goes along the route direction, that is, θ0=0, vehicle azimuth θ and vehicle position (x, y) after movement over movement period Ts can be calculated by Equation 5. Note that γt and Vt are a yaw rate and a true value of vehicle speed.

$$0 = γ t \cdot Ts \qquad [ Equation 5 ]$$

$$x = x 0 + Vt \cdot Ts \cdot cos ( θ ) ≃ x 0 + Vt \cdot Ts$$

$$y = y 0 + Vt \cdot Ts \cdot sin ( 0 ) ≃ y 0 + Vt \cdot Ts ( γ t \cdot Ts )$$

Note that θ in Equation 5 is a change amount of vehicle azimuth, and is sufficiently small. In Equation 5, as with Equation 1 described above, technical approximation based on the fact that this θ is sufficiently small is included.

When a measurement value of yaw rate by IMU 22 is (γt+γe) including error γe and a measurement value of vehicle speed based on the vehicle speed signal of wheel speed sensor 55 is (Vt+Ve) including error Ve, vehicle azimuth θe and relative position (xe, ye) are as in Equation 6.

$${0}^{′} = ( γ t + γ e ) Ts , \qquad [ Equation 6 ]$$

$$\begin{matrix}{x}^{′} = x 0 + Vt cos ( {θ}^{′} ) ≃ x 0 + ( Vt + Ve ) Ts \\ = x 0 + VtTs + VeTs\end{matrix} ,$$

$$\begin{matrix}{y}^{′} = y 0 + Vt sin ( {θ}^{′} ) ≃ y 0 + ( Vt + Ve ) Ts ( γ t + γ e ) Ts \\ = y 0 + VtTs γ Ts - ( Vt γ e + Ve γ + Ve γ e ) {Ts}^{2}\end{matrix}$$

Error de of vehicle azimuth by autonomous navigation using yaw rate (γt+γe) measured by IMU 22 and vehicle speed (Vt+Ve) based on the vehicle speed signal of wheel speed sensor 55, and relative position error (xe, ye) are as in Equation 7.

$$θ e = {θ}^{′} - 0 = γ eTs , \qquad [ Equation 7 ]$$

$$x e = {x}^{′} - x = VeTs ,$$

$$y e = {y}^{′} - y = ( Vt γ e + Ve γ t + Ve γ e ) {Ts}^{2}$$

As in Equation 7, error xe of the relative position in the front-rear direction of the vehicle (vehicle azimuth) is calculated by multiplying vehicle speed error Ve and movement time Ts, that is, by a linear equation of an error variable Ve. By contrast, an equation for calculating error ye of the relative position in the width direction of the vehicle includes multiplication of vehicle speed error Ve and yaw rate error γe. With multiplication of vehicle speed error Ve and yaw rate error γe, influences of error expands. Thus, when error xe of the relative position in the front-rear direction of the vehicle and error ye of the relative position in the width direction of the vehicle are compared, error ye receives more influences of yaw rate error γe and vehicle speed error Ve than error xe, and the error can increase.

Thus, in the present embodiment, the size of prescribed range A described above where a newly-detected magnetic marker can be located is gradually expanded, as in FIG. 12, in accordance with the movement distance of vehicle 5 after passing over reference position (x, y). Furthermore, in the configuration of the present embodiment, in view of expansion tendency of error xe of the relative position in the front-rear direction of the vehicle and error ye of the relative position in the width direction of the vehicle, an enlargement ratio of prescribed range A in the front-rear direction of the vehicle and an enlargement ratio thereof in the width direction of the vehicle are different.

In the present embodiment, as in FIG. 12, when vehicle 5 moves along a path indicated by a broken line after passing over reference position (x, y), prescribed range A is gradually deformed from a nearly-circular state to an oval. Furthermore, prescribed range A has a compression (aspect ratio) of the oval increased in accordance with the movement distance and extends in the vehicle-width direction. Setting this prescribed range A is setting in consideration of the fact that, as described above, error ye of the relative position in the width direction of the vehicle tends to receive more influences of yaw rate error γe and vehicle speed error Ve than error xe of the relative position in the front-rear direction of the vehicle and the error can increase.

Specifically, by using maximum error VE of vehicle speed by wheel speed sensor 55 and maximum error γE of yaw rate by IMU 22, a short radius xl and a long radius yl of prescribed range A are set by the following equation 8. Note that in the present embodiment, an error value corresponding to 3σ, which is a triple of standard deviation σ error distribution, is set as the maximum error.

$$x 1 = VETs \qquad [ Equation 8 ]$$

$$y 1 = ( Vt γ E + VE γ t + VE γ E ) {Ts}^{2}$$

Threshold process regarding the size of prescribed range A may be performed. As a situation in which prescribed range A becomes excessive, a situation can be thought in which a situation in which no magnetic marker has been detected continues to cause the movement distance after passage over the reference position to become excessive. In this case, there is a possibility of occurrence of some trouble, such as a failure of a magnetic sensor or departure from the route. In this case, notification indicating that prescribed range A becomes excessive and/or stopping vehicle control such as automatic traveling may be made.

Note that other configurations and operations and effects are similar to those of the first embodiment.

In the foregoing, while specific examples of the present invention are described in detail as in the embodiments, these specific examples merely disclose examples of technology included in the scope of the claims. Needless to say, the scope of the claims should not be restrictively construed based on the configuration, numerical values, and so forth of the specific examples. The scope of the claims includes technologies acquired by variously modifying, changing, or combining as appropriate the above-described specific examples by using known technologies, knowledge of a person skilled in the art, and so forth.

### REFERENCE SIGNS LIST

1 vehicular system
1R route
1P discrete point
10 magnetic marker
2 measuring unit
21 sensor array (marker detecting part)
212 detection processing circuit
22 IMU
223 biaxial gyro sensor (second sensor)
3 control unit
31 first positioning circuit
32 second positioning circuit
34 database
35 control circuit
5 vehicle
55 wheel speed sensor (first sensor)

1. A vehicular system for causing a vehicle to automatically travel by using magnetic markers disposed in a route, the system comprising:
a database recording position data of discrete points on the route;
a marker detecting part provided to the vehicle to detect a magnetic marker of the magnetic markers;
a first positioning circuit that measures an own vehicle position, which is a position of the vehicle, with reference to a laying position of the magnetic marker detected by the marker detecting part;
a second positioning circuit that measures the own vehicle position in an intermediate period after the magnetic marker is detected until a new magnetic marker is detected by the marker detecting part; and
a control circuit that controls traveling of the vehicle by taking a deviation of the own vehicle position measured by the first positioning circuit or the second positioning circuit with respect to the route as a control target, wherein
in the database, marker position data indicating a relative position of the magnetic marker with reference to a position of any of the discrete points is recorded as linked to the position data of the discrete points,
the first positioning circuit is configured to identify, when the magnetic marker is detected by the marker detecting part, the magnetic marker positioned in a prescribed range with reference to the own vehicle position by the second positioning circuit by referring to the database, and
the control circuit is configured to identify the deviation of the own vehicle position measured by the first positioning circuit or the second positioning circuit with respect to the route by referring to the position data recorded on the database.

2. The vehicular system in claim 1, wherein the first positioning circuit identifies the laying position of the magnetic marker corresponding to the marker position data by positionally shifting from a discrete point regarding the position data to which the marker position data is linked by the relative position indicated by the marker position data recorded on the database and determines whether the laying position belongs to the prescribed range, and can thereby identify the magnetic marker positioned in the prescribed range.

3. The vehicular system in claim 1, wherein, for each piece of position data to which the marker position data is linked among the position data recorded on the database, the first positioning circuit is configured to determine whether the laying position of the magnetic marker indicated by the linked marker position data belongs to the prescribed range and identify the magnetic marker positioned in the prescribed range.

4. The vehicular system in claim 1, wherein the control circuit is configured to enlarge a size of the prescribed range in accordance of a traveling distance after the first positioning circuit identifies the own vehicle position.

5. The vehicular system in claim 4, wherein the vehicle is provided with a first sensor that obtains a physical amount that can identify an amount of revolution of a wheel and a second sensor that obtains a rotational angular velocity of the vehicle about an axis in a vertical direction,
the control circuit is configured to estimate a displacement of the vehicle in a traveling direction by using the amount of revolution of the wheel and estimate a displacement of the vehicle in a vehicle-width direction by using the amount of revolution of the wheel and the rotational angular velocity of the vehicle, and
an enlargement ratio when the control circuit enlarges the size of the prescribed range in accordance with the traveling distance is different between the traveling direction and the vehicle-width direction, and the enlargement ratio in the vehicle-width direction is set larger.

6. The vehicular system in claim 5, wherein the control circuit is configured to perform a threshold process regarding the traveling distance and, when the traveling distance exceeds a prescribed distance set in advance, make notification as such or stop control of causing the vehicle to automatically travel.

7. The vehicular system in claim 1, wherein the position data of the discrete points includes coordinate data indicating a position of a discrete point of the discrete points and azimuth data indicating a direction of the route at the discrete point, and
the marker position data is coordinate data indicating a position on two-dimensional coordinates with an axis along the direction of the route and an axis along a direction orthogonal to the direction of the route.

8. The vehicular system in claim 1, wherein the database includes a database for each vehicle type of the vehicle and, on the database for the each vehicle type, the position data of the discrete points varied for the each vehicle type is recorded, and
the system is configured, when the vehicle detects the magnetic marker, by referring to the database corresponding to a vehicle type to which the vehicle belongs, to adjust, for the each vehicle type, a target route when the vehicle travels.

9. The vehicular system in claim 1, wherein the system is configured that a marker flag indicating whether the marker position data is linked is linked to the position data of the discrete points recorded on the database and, by referring to the marker flag, the system is configured to determine whether the marker position data is linked to the position data of the discrete point.

10. A control method for causing a vehicle to automatically travel by using magnetic markers disposed in a route, the method comprising:
i) providing a vehicular system having:
a database recording position data of discrete points on the route;
a marker detecting part provided to the vehicle to detect a magnetic marker of the magnetic markers;
a first positioning circuit that measures an own vehicle position, which is a position of the vehicle, with reference to a laying position of the magnetic marker detected by the marker detecting part;
a second positioning circuit that measures the own vehicle position in an intermediate period after the magnetic marker is detected until a new magnetic marker is detected by the marker detecting part; and
a control circuit that controls traveling of the vehicle by taking a deviation of the own vehicle position measured by the first positioning circuit or the second positioning circuit with respect to the route as a control target, wherein
in the database, marker position data indicating a relative position of the magnetic marker with reference to a position of any of the discrete points is recorded as linked to the position data of the discrete points,
ii) identifying, by the first positioning circuit, when the magnetic marker is detected by the marker detecting part, the magnetic marker positioned in a prescribed range with reference to the own vehicle position by the second positioning circuit by referring to the database; and
iii) identifying, by the control circuit, the deviation of the own vehicle position measured by the first positioning circuit or the second positioning circuit with respect to the route by referring to the position data recorded on the database.

11. The vehicular system in claim 2, wherein the control circuit is configured to enlarge a size of the prescribed range in accordance of a traveling distance after the first positioning circuit identifies the own vehicle position.

12. The vehicular system in claim 3, wherein the control circuit is configured to enlarge a size of the prescribed range in accordance of a traveling distance after the first positioning circuit identifies the own vehicle position.

13. The vehicular system in claim 11, wherein the vehicle is provided with a first sensor that obtains a physical amount that can identify an amount of revolution of a wheel and a second sensor that obtains a rotational angular velocity of the vehicle about an axis in a vertical direction,
the control circuit is configured to estimate a displacement of the vehicle in a traveling direction by using the amount of revolution of the wheel and estimate a displacement of the vehicle in a vehicle-width direction by using the amount of revolution of the wheel and the rotational angular velocity of the vehicle, and
an enlargement ratio when the control circuit enlarges the size of the prescribed range in accordance with the traveling distance is different between the traveling direction and the vehicle-width direction, and the enlargement ratio in the vehicle-width direction is set larger.

14. The vehicular system in claim 12, wherein the vehicle is provided with a first sensor that obtains a physical amount that can identify an amount of revolution of a wheel and a second sensor that obtains a rotational angular velocity of the vehicle about an axis in a vertical direction,
the control circuit is configured to estimate a displacement of the vehicle in a traveling direction by using the amount of revolution of the wheel and estimate a displacement of the vehicle in a vehicle-width direction by using the amount of revolution of the wheel and the rotational angular velocity of the vehicle, and
an enlargement ratio when the control circuit enlarges the size of the prescribed range in accordance with the traveling distance is different between the traveling direction and the vehicle-width direction, and the enlargement ratio in the vehicle-width direction is set larger.

15. The vehicular system in claim 13, wherein the control circuit is configured to perform a threshold process regarding the traveling distance and, when the traveling distance exceeds a prescribed distance set in advance, make notification as such or stop control of causing the vehicle to automatically travel.

16. The vehicular system in claim 14, wherein the control circuit is configured to perform a threshold process regarding the traveling distance and, when the traveling distance exceeds a prescribed distance set in advance, make notification as such or stop control of causing the vehicle to automatically travel.
